(19) United States
(12) Patent Application Publication
(10) Pub. No.: US 2022/0207360 A1
(43) Pub. Date: Jun. 30, 2022

(54) COMPUTER SYSTEM FOR MULTI-SOURCE DOMAIN ADAPTATIVE TRAINING BASED ON SINGLE NEURAL NETWORK WITHOUT OVERFITTING AND METHOD THEREOF

(71) Applicant: Korea Advanced Institute of Science and Technology, Daejeon (KR)

(72) Inventors: Sang Wan LEE, Daejeon (KR); Geon Yeong PARK, Daejeon (KR)

(21) Appl. No.: 17/547,166

(22) Filed: Dec. 9, 2021

(30) Foreign Application Priority Data
Dec. 24, 2020 (KR) 10-2020-0183859

(51) Int. Cl. G06N 3/08; G06N 3/10

(52) U.S. Cl. CPC G06N 3/08; G06N 3/10

(57) ABSTRACT

Various embodiments relate to a computer system for multi-source domain adaptative training based on a single neural network without overfitting and a method thereof. The various embodiments may configured to regularize data sets of a plurality of domains, extract information shared between the regularized data sets, and implement a training model by performing training based on the extracted information.

### CROSS-REFERENCES TO RELATED APPLICATIONS

This application is based on and claims priority under 35 U.S.C. 119 to Korean Patent Application No. 10-2020-0183859, filed on Dec. 24, 2020 in the Korean intellectual property office, the disclosure of which is herein incorporated by reference in its entirety.

### TECHNICAL FIELD

Various embodiments relate to a computer system for multi-source domain adaptative training based on a single neural network without overfitting and a method thereof.

### BACKGROUND OF THE DISCLOSURE

A conventional learning machine method, such as deep learning, is limited to a single domain. A model trained through specific domain data is overfitted and cannot be directly used in another domain. Accordingly, the model additionally requires labeled data in order to be used in another domain. In this process, a lot of expense occurs.

In order to solve the problem, a domain adaptation methodology having an object of performance improvement in a target domain by using labeled data of the existing domain and unlabeled data of the target domain has been researched. However, scalability is greatly reduced and information that is available in common cannot be extracted from domains at a time because a case where data is simultaneously collected from several domains is not taken into consideration.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Various embodiments provide a computer system capable of learning data sets of a plurality of domains at a time by using a single neural network and a method thereof.

Various embodiments provide a computer system capable of extracting information shared between domains and learning shared information without overfitting and a method thereof.

In various embodiments, a method by a computer system may include regularizing data sets of a plurality of domains, extracting information shared between the regularized data sets, and implementing a training model by performing training based on the extracted information.

In various embodiments, a computer system may include a memory and a processor connected to the memory and configured to execute at least one instruction stored in the memory. The processor may configured to regularize data sets of a plurality of domains, extract information shared between the regularized data sets, and implement a training model by performing training based on the extracted information.

In various embodiments, a non-transitory computer-readable storage medium may store one or more programs for regularizing data sets of a plurality of domains, extracting information shared between the regularized data sets, and implementing a training model by performing training based on the extracted information.

According to various embodiments, the computer system can prevent overfitting for some of domains of the training model because the computer system implements the training model from data sets after regularizing the data sets of multiple domains.

According to various embodiments, the computer system can implemented the training model by using even a single neural network, that is, without adding another neural network, because the computer system implements the training model based on information shared between data sets of multiple domains.

According to various embodiments, an implemented training model can have further improved performance because the computer system reinforces the complexity of feature data to be extracted from each of data sets when regularizing the data sets. That is, a problem in that the feature data extracted from the data sets is simplified when the data sets are regularized can be prevented.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a diagram illustrating a computer system according to various embodiments.

FIG. 2 is a diagram for conceptually describing an operating characteristic of the computer system of FIG. 1.

FIG. 3 is a diagram for illustratively describing an operating characteristic of the computer system of FIG. 1.

FIG. 4 is a diagram illustrating a method by a computer system according to various embodiments.

FIGS. 5A, 5B and 5C are diagrams for describing operating performance of the computer system 100 according to various embodiments.

FIGS. 6A and 6B are diagrams for describing operating performance of the computer system 100 according to various embodiments.

FIGS. 7A and 7B are diagrams for describing operating performance of the computer system 100 according to various embodiments.

### DETAILED DESCRIPTION

While illustrative embodiments have been illustrated and described, it will be appreciated that various changes can be made therein without departing from the spirit and scope of the disclosure.

Hereinafter, various embodiments of this document are described with reference to the accompanying drawings.

In the existing deep learning field, in order to supplement insufficient data and obtain a model which can be more generalized, an adversarial domain adaptation methodology for transferring a trained model to another domain has been researched. To this end, a domain classification model for classifying information of the existing domain and a target domain is required. In the existing methodology, however, 1) efficiency of computing source utilization and 2) the information extraction ability are greatly reduced in a common situation in which available existing domains are several. For example, if big data is given and available existing domains are exponentially increased, it is difficult to handle domain classification models increased in response thereto and corresponding computing resources. Furthermore, available information cannot be complementarily encoded in several domains because encoded information is independent in each of not-unified domain classification models. Accordingly, it is difficult to check a common basic principle hidden in given multi-domain data.

Such a problem may be solved through the development of a multi-domain adaptation model based on an information theory. (1) There is proposed a theoretical background of a unified model for classifying several domains at a time by interpreting the existing domain adaptation as a mutual information quantity regularization process between a domain and an extraction feature. (2) Furthermore, there is proposed a single domain classification model based on a convolution neural network. Accordingly, a large amount of the existing domain data can be used without limit, and basic knowledge between domains can also be shared because useful information not limited to a specific domain is encoded. (3) Furthermore, in order to solve the simplification problem of an extraction feature occurring because the existing domain adaptation method limits the amount of mutual information, a gradual extraction feature complexity improvement algorithm is developed. Accordingly, a trained model can be transferred to a target domain without a danger of performance degradation in the existing trained domain.

Various embodiments relate to a batch information processing and encoding system for data of multiple domains, and handle a technology for transferring a model to a target domain without a danger of overfitting. Such a technology for a single domain classification neural network is a core technology in meta-artificial intelligence development capable of a multi-task. Furthermore, the technology has high flexibility and has no similar example of research in that it does not require additional data generation, network extension and addition, previous training, etc.

Various embodiments provide a technology for (1) encoding information by using all of available domain data, (2) successfully transferring the extracted information to a target domain, and (3) training a model in this process without a danger of simplification.

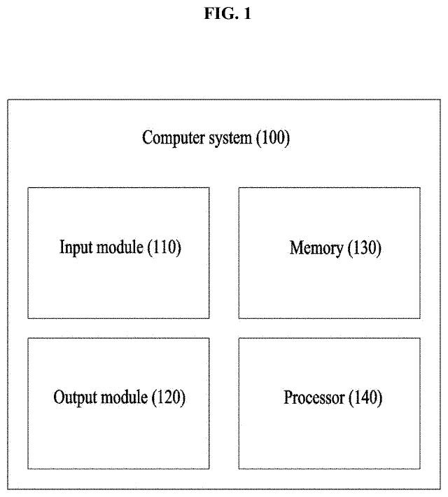

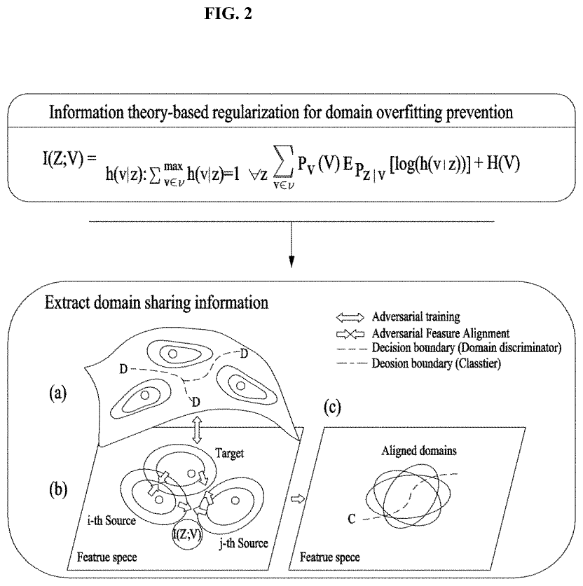

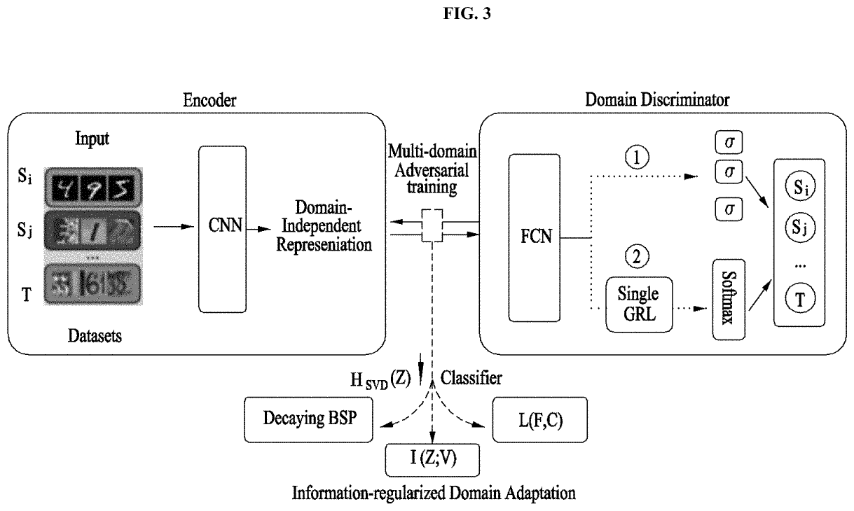

FIG. 1 is a diagram illustrating a computer system 100 according to various embodiments. FIG. 2 is a diagram for conceptually describing an operating characteristic of the computer system 100 of FIG. 1. FIG. 3 is a diagram for illustratively describing an operating characteristic of the computer system 100 of FIG. 1.

Referring to FIG. 1, the computer system 100 according to various embodiments may include at least one of an input module 110, an output module 120, a memory 130, or a processor 140. In an embodiment, at least one of the components of the computer system 100 may be omitted, and at least another component may be added to the computer system 100. In an embodiment, at least two of the components of the computer system 100 may be implemented as one integrated circuit. In this case, the computer system 100 may include at least one device, for example, at least one of at least one server or at least one electronic device. In an embodiment, if the computer system 100 includes a plurality of devices, the components of the computer system 100 may be configured in one of the devices or may be distributed and configured in at least two of them.

The input module 110 may input a signal to be used in at least one of the components of the computer system 100. The input module 110 may include at least one of an input device that enables a user to directly input a signal to the computer system 100, a sensor device configured to generate a signal by detecting a surrounding change, or a reception device configured to receive a signal from an external device. For example, the input device may include at least one of a microphone, a mouse or a keyboard. In an embodiment, the input device may include at least one of touch circuitry configured to detect a touch or sensor circuitry configured to measure the intensity of a force generated by a touch.

The output module 120 may output information to the outside of the computer system 100. The output module 120 may include at least one of a display device configured to visually output information, an audio output device capable of outputting an audio signal, or a transmission device capable of wirelessly transmitting information. For example, the display device may include at least one of a display, a hologram or a projector. For example, the display device may be implemented as a touch screen by being assembled with at least one of the touch circuitry or sensor circuitry of the input module 110. For example, the audio output device may include at least one of a speaker or a receiver.

According to an embodiment, the reception device and the transmission device may be implemented as a communication module. The communication module may perform communication with an external device in the computer system 100. The communication module may establish a communication channel between the computer system 100 and the external device, and may perform communication with the external device through the communication channel. In this case, the external device may include at least one of a satellite, a base station, a server or another computer system. The communication module may include at least one of a wired communication module or a wireless communication module. The wired communication module may be connected to an external device through wires, and may communicate with the external device through wires. The wireless communication module may include at least one of a short-distance communication module or a long-distance communication module. The short-distance communication module may communicate with an external device by using a short-distance communication method. For example, the short-distance communication method may include at least one of Bluetooth, WiFi direct, or infrared data association (IrDA). The long-distance communication module may communicate with an external device by using a long-distance communication method. In this case, the long-distance communication module may communicate with the external device over a network. For example, the network may include at least one of a cellular network, the Internet, or a computer network, such as a local area network (LAN) or a wide area network (WAN).

The memory 130 may store various data used by at least one of the components of the computer system 100. For example, the memory 130 may include at least one of a volatile memory or a nonvolatile memory. The data may include at least one program and input data or output data related to the at least one program. The program may be stored in the memory 130 as software including at least one instruction, and may include at least one of an operating system, middleware or an application.

The processor 140 may control at least one of the components of the computer system 100 by executing a program of the memory 130. Accordingly, the processor 140 may perform data processing or an operation. In this case, the processor 140 may execute instructions stored in the memory 130.

According to various embodiments, the processor 140 may regularize data sets of a plurality of domains. In order to prevent overfitting for some of the domains, the processor 140 may regularize the data sets of the domains. That is, as illustrated in FIG. 2, the processor 140 may regularize (I(Z; V)) data sets based on an information theory for overfitting prevention. In this case, the processor 140 may extract feature data having the amount of regularized information from each of the data sets. For example, the processor 140 may include a classifier. As illustrated in FIG. 3, the classifier may extract feature data (L(F, C)) from each of data sets.

According to embodiments, the processor 140 may extract feature data from each of data sets while reinforcing the complexity of the feature data to be extracted. According to an embodiment, the processor 140 may gradually reinforce the complexity. In this case, the processor 140 may reinforce the complexity by using a batch spectral penalization (BSP) algorithm. For example, the processor 140 may reinforce the complexity by using a decaying BSP algorithm. Accordingly, at least one problem which may occur as data sets are regularized can be prevented. For example, when data sets are regularized, a problem in that feature data extracted from the data sets is simplified can be prevented.

According to various embodiments, the processor 140 may extract information shared between data sets. The processor 140 may extract the information shared between the data sets over a single neural network. According to an embodiment, the single neural network may be a convolution neural network (CNN). That is, as illustrated in FIG. 2, the processor 140 may extract shared information with respect to a plurality of domains. In FIG. 2, ellipses may indicate domains or the data sets of domains, respectively. Ellipses corresponding to domains may be substantially individually present as illustrated in FIG. 2(a). In such a case, as illustrated in FIG. 2(b), the processor 140 may arrange ellipses corresponding to domains while analyzing data sets, and may resultantly overlap the ellipses corresponding to the domains as illustrated in FIG. 2(c). In this case, an area where the ellipses overlap may indicate shared information of the data sets. Through such a method, the processor 140 may extract shared information of data sets. For example, as illustrated in FIG. 3, the processor 140 may include an encoder. The encoder may encode data sets over a single neural network and extract shared information. In this case, the processor 140 may extract the shared information based on feature data from each of the data sets.

According to various embodiments, the processor 140 may implement a training model by performing training based on shared information. Accordingly, the processor 140 may implement the training model in relation to a plurality of domains. That is, the processor 140 may implement the training model in relation to all domains without being limited to some of the domains. For example, as illustrated in FIG. 3, the processor 140 may include a single discriminator. The single discriminator may perform adversarial training based on shared information. Accordingly, the computer system 100 may implement the training model for a plurality of domains through adversarial adaptative training.

According to various embodiments, the processor 140 may transfer a training model to a target domain. Accordingly, the training model may be used in the target domain.

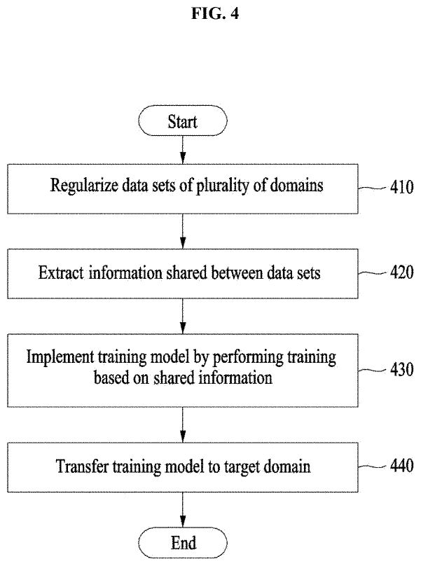

FIG. 4 is a diagram illustrating a method by the computer system 100 according to various embodiments. In this case, FIG. 4 illustrates a method for multi-source domain adaptative training based on a single neural network without overfitting by the computer system 100.

Referring to FIG. 4, in step 410, the computer system 100 may regularize data sets of a plurality of domains. In order to prevent overfitting for some of the domains, the computer system 100 may regularize the data sets of the domains. That is, the processor 140 may regularize (I(Z; V)) the data sets based on an information theory for overfitting prevention, such as that illustrated in FIG. 2. In this case, the processor 140 may extract feature data having the amount of regularized information from each of the data sets. For example, as illustrated in FIG. 3, the processor 140 may extract feature data (L(F, C)) from each of the data sets through the classifier.

According to embodiments, the processor 140 may extract feature data from each of data sets while reinforcing the complexity of the feature data to be extracted. According to an embodiment, the processor 140 may gradually reinforce the complexity. In this case, the processor 140 may reinforce the complexity by using the BSP algorithm. For example, the processor 140 may reinforce the complexity by using the decaying BSP algorithm. Accordingly, at least one problem which may occur as data sets are regularized can be prevented. For example, a problem in that feature data extracted from data sets is simplified when the data sets are regularized can be prevented.

In step 420, the computer system 100 may extract information shared between the data sets. The computer system 100 may extract the shared information between the data sets over a single neural network. According to an embodiment, the single neural network may be a convolution neural network (CNN). That is, as illustrated in FIG. 2, the processor 140 may extract the shared information with respect to the plurality of domains. For example, as illustrated in FIG. 3, the processor 140 may encode the data sets over the single neural network through the encoder, and may extract the shared information. In this case, the processor 140 may extract the shared information based on feature data from each of the data sets.

In step 430, the computer system 100 may implement a training model by performing training based on the shared information. Accordingly, the computer system 100 may implement the training model in relation to the plurality of domains. That is, the processor 140 may implement the training model in relation to all of domains without being limited to some of the domains. For example, as illustrated in FIG. 3, the processor 140 may adversarial training based on the shared information through the single discriminator. Accordingly, the computer system 100 may implement the training model for the plurality of domains through the adversarial adaptative training.

In step 440, the computer system 100 may transfer the training model to a target domain. Accordingly, the training model may be used in the target domain.

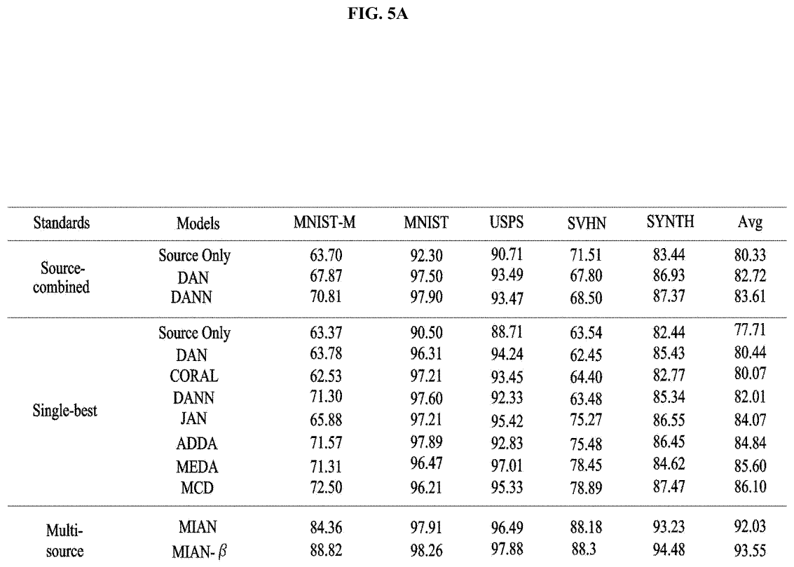

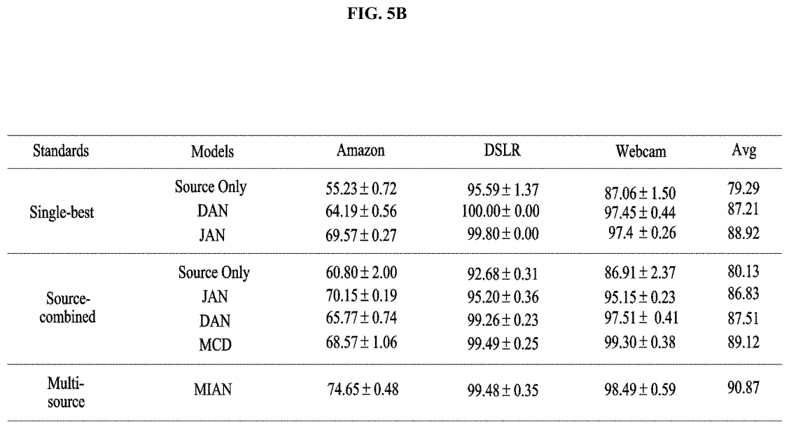

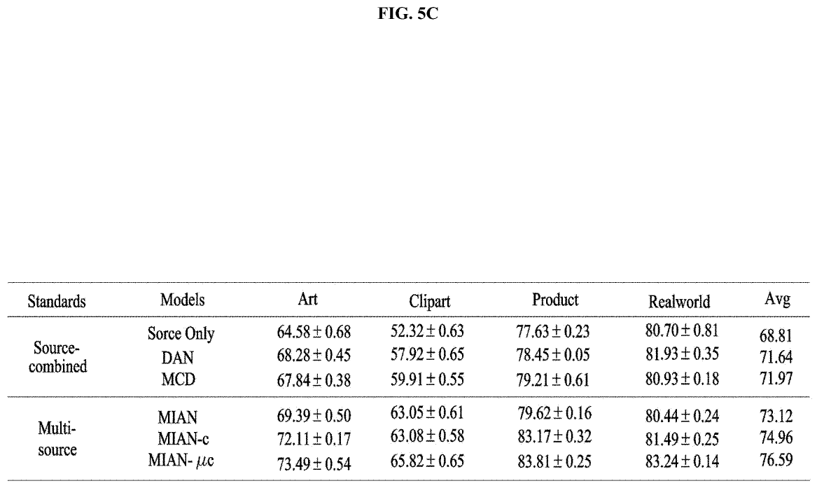

FIGS. 5a, 5b and 5c are diagrams for describing operating performance of the computer system 100 according to various embodiments. In this case, FIGS. 5A, 5B and 5C illustrate simulation results of the computer system 100 according to various embodiments. FIG. 5A is a table illustrating adaptation performance of five domains of a training model implemented with respect to the five domains related to the recognition of number images. FIG. 5B is a table illustrating adaptation performance for each of three domains of a training model implemented with respect to the three domains related to the classification of photo-based office supplies. FIG. 5C is a table illustrating adaptation performance for four domains of a training model implemented with respect to the four domains related to the classification of virtual graphics and physical count-based office supplies.

Referring to FIGS. 5A, 5B and 5C, the computer system 100 according to various embodiments has excellent operating performance. In this case, “Source-combined” is a case where the training model is implemented by simply combining the datasets of the domains. “Single-best” is a case where the training model is implemented based on one of the domains, that is, a data set of the best domain. “Multi-source” is a case where the training model is implemented according to various embodiments. In this case, the training model is implemented based on shared information of the data sets of the plurality of domains. Accordingly, the training model shows excellent adaptation performance for each of the domains. That is, the computer system 100 can implement the training model having excellent adaptation performance regardless of the number of domains.

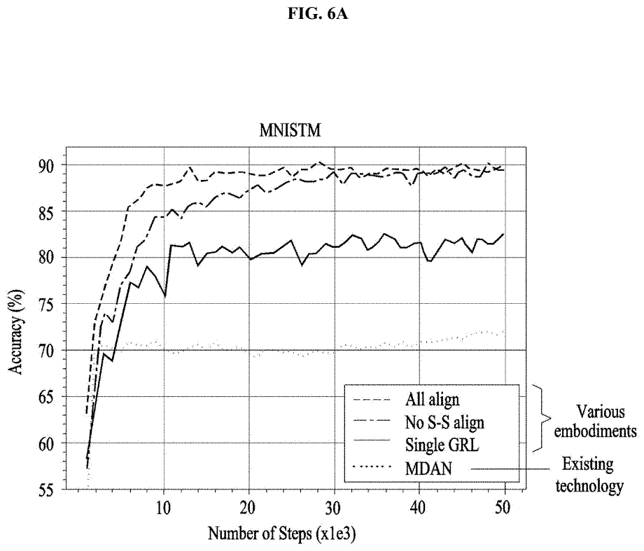

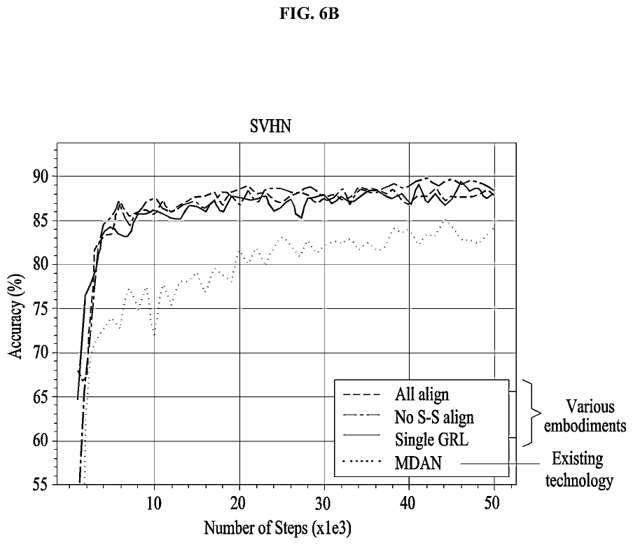

FIGS. 6a and 6b are diagrams for describing operating performance of the computer system 100 according to various embodiments. In this case, FIGS. 6A and 6B illustrate operation accuracy of a training model implemented by the computer system 100 according to various embodiments and a training model implemented by the existing technology. In this case, FIGS. 6A and 6B are graphs illustrating operation accuracy for different domains.

Referring to FIGS. 6A and 6B, the computer system 100 according to various embodiments have excellent operating performance. According to various embodiments, the training model is implemented based on shared information of data sets of a plurality of domains. Accordingly, the training model according to various embodiments indicates high accuracy for each of domains compared to the training model of the existing technology. That is, the computer system 100 can implement a training model having high accuracy for any domain.

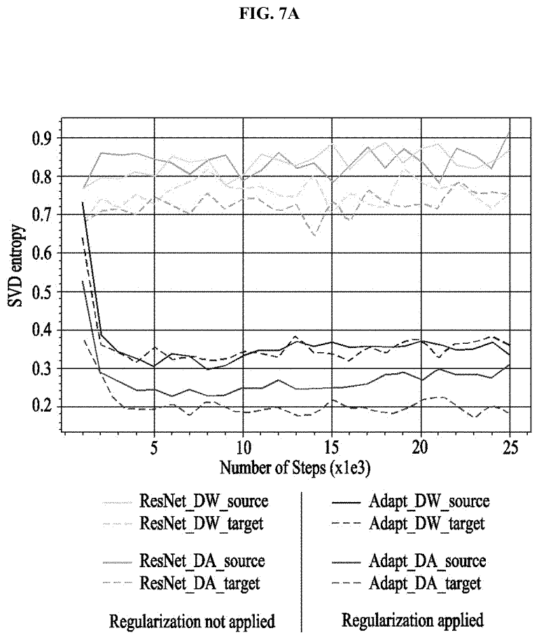

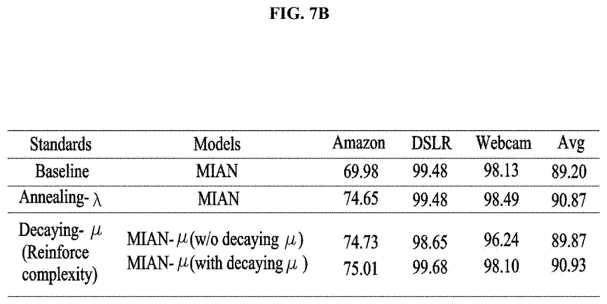

FIGS. 7A and 7B are diagrams for describing operating performance of the computer system 100 according to various embodiments. In this case, FIG. 7A is a graph for describing a problem which may occur as data sets are regularized. FIG. 7B is a table for describing that the problem in the computer system 100 according to various embodiments is solved.

Referring to FIG. 7A, when data sets are regularized, the complexity of feature data extracted from the data sets may be decreased. In this case, the complexity may be represented as entropy. According to various embodiments, when regularizing data sets, the computer system 100 may reinforce the complexity of feature data to be extracted. That is, the computer system 100 may extract the feature data from each of the data sets while reinforcing the complexity of the feature data to be extracted, and may implement a training model based on the extracted feature data. According to various embodiments, as the complexity of extracted feature data is reinforced, a training model has further improved adaptation performance for each of domains as illustrated in FIG. 7B. In this case, the computer system 100 may reinforce the complexity by using the BSP algorithm. In this case, the computer system 100 may further reinforce the complexity by using the decaying BSP algorithm. Accordingly, a problem in that the feature data extracted from the data sets is simplified when the data sets are regularized can be prevented.

According to various embodiments, the computer system 100 can prevent overfitting for some of domains of a training model because the computer system 100 regularizes data sets of multiple domains and implements a training model from the data sets. According to various embodiments, the computer system 100 can implement a training model by using even a single neural network, that is, without adding another neural network, because the computer system 100 implements a training model based on shared information shared between data sets of multiple domains. According to various embodiments, when regularizing data sets, the computer system 100 reinforces the complexity of feature data to be extracted from each of the data sets. Accordingly, the implemented training model can have better improved performance. That is, a problem in that the feature data extracted from the data sets is simplified when the data sets are regularized can be prevented.

According to various embodiments, a method by the computer system 100 may include a step of regularizing data sets of a plurality of domains, a step of extracting information shared between the regularized data sets, and a step of implementing a training model by performing training based on the extracted shared information.

According to various embodiments, the method by the computer system 100 may further include a step of transferring the training model to a target domain.

According to various embodiments, the step of extracting shared information may extract the shared information by encoding the regularized data sets over a single neural network.

According to various embodiments, the single neural network may be a convolution neural network (CNN).

According to various embodiments, the step of regularizing the data sets may include a step of extracting, from each of the data sets, feature data to be inputted to the neural network.

According to various embodiments, the step of extracting shared information may include a step of extracting the shared information based on feature data.

According to various embodiments, the step of regularizing the data sets may include reinforcing the complexity of feature data to be extracted from each of the data sets by using the BSP algorithm.

According to various embodiments, the step of implementing the training model may include performing adversarial training through the single discriminator.

According to various embodiments, the computer system 100 may include the memory 130, and the processor 140 connected to the memory 130 and configured to execute at least one instruction stored in the memory 130.

According to various embodiments, the processor 140 may be configured to regularize data sets of a plurality of domains, extract information shared between the regularized data sets, and implement a training model by performing training based on the extracted information.

According to various embodiments, the processor 140 may be configured to transfer the training model to a target domain.

According to various embodiments, the processor 140 may include the encoder configured to extract the shared information by encoding the regularized data sets over a single neural network.

According to various embodiments, the single neural network may be a convolution neural network (CNN).

According to various embodiments, the processor 140 may be configured to extract, from each of the data sets, feature data to be inputted to the neural network and extract the shared information based on the feature data.

According to various embodiments, the processor 140 may be configured to reinforce the complexity of feature data to be extracted from each of the data sets by using the BSP algorithm.

According to various embodiments, the processor 140 may include the single discriminator configured to perform adversarial training.

Various embodiments can be actively applied to fields that require abundant scalability because data of a given domain can be thoroughly learnt and a basic principle learnt from several domains can be purified and used in another target domain. For example, the field may include the following fields.

The first is a medical AI field. In the development of artificial intelligence that helps clinical diagnosis and treatment, positive data is essentially used. However, it is difficult for an artificial intelligence model to learn medical data by comprehensively using the medical data because the medical data is collected through various medical instruments (e.g., an X-ray, an MRI, and CT) in terms of its nature. The medical data has a danger of overfitting for specific data even after the learning. The present system can assist more accurate diagnosis by identifying a basic principle shared between data of several medical fields in addition to the training of a model by simply collecting several data. Furthermore, the present system can efficiently use data by learning all the data having given several formats. Moreover, in view of a specific cultural, social or periodic characteristic, medical data is likely to be statistically diversified. For example, a distribution and statistics of overall data may be suddenly changed by a large amount of infectious diseases (e.g., COVID-19) or there may be a difference between ethnic group races or cultural characteristics due to the distribution and statistics. The present system can be used to construct a medical diagnosis algorithm which is universal and flexibly applied by considering a difference between various data which may be obtained.

The second is an autonomous driving field. Data for an autonomous vehicle is essentially accompanied by various environment changes in a collection process. Data is classified into several domains due to a season upon driving, the amount of light, a location, the type of vehicle, an angle of view of a camera, or a temporal change, for example. Context of such data needs to be essentially understood in successful autonomous driving. The present system can process a large amount of data simultaneously collected from various domains in parallel and in batches based on high scalability, and efficiently uses given computing resources in this process. Accordingly, the present system can flexibly respond to the aforementioned environment change and can be used in the development of an autonomous driving algorithm having secured safety.

The third is a machine translation/natural language processing field. In the machine translation field, training is performed using a large amount of text corpus collected in several cultural regions and language regions. The existing machine translation technology cannot be applied to a specific professional field and a minority language region because data capable of being collected from the specific professional field and the minority language region is limited unlike in the collection of a large amount of data in English-American and western culture regions. The present system can identify a basic language principle by using a large amount of the existing available corpus data, and can obtain a model applicable to various language regions by applying the basic language principle to another target domain.

The fourth is a personalization field. In personalization fields such as advertising proposals and the recommendation of mobile content, it is necessary to identify behavior characteristics of numerous users. However, it is difficult to universally apply a trained model because data collected from various platforms and devices includes a statistical difference between user data. If this technology is used, a universal recommendation model which can be transferred to a specific target user group can be developed by identifying preference based on data collected from various users or platforms.

The volume and diversity of collected data gradually become huge due to the development of clouds and mobile markets, but the existing artificial intelligence model does not properly consider such a data profile. The proposal technology designed to process data collected from several domains in parallel and use the data in various types of context can be widely used in all automation-related markets that require flexibility, including the medical and autonomous driving fields.

In the case of a developing country or a specific professional group or a cultural region, it is difficult to process and secure data because the development speed of digital and mobile environments is not supported. For this reason, such cultural and geographical characteristics may not be sufficiently incorporated in a trained model. The present system can contribute to the development of socially fair artificial intelligence by training a model based on the existing large amount of data and transferring the model to the special environment.

The proposal technology collects data through paths, such as various media and platforms, and can be applied to all companies and services in which the data is to be generalized. For example, the proposal technology can be used in artificial intelligence-based healthcare and clinical diagnosis technology development companies, media platform development companies, artificial intelligence technology-based manufacturing companies such as smart factories, autonomous driving technology development companies, etc.

The aforementioned device may be implemented as a hardware component, a software component and/or a combination of a hardware component and software component. For example, the device and component described in the embodiments may be implemented using a processor, a controller, an arithmetic logic unit (ALU), a digital signal processor, a microcomputer, a field programmable gate array (FPGA), a programmable logic unit (PLU), a microprocessor or one or more general-purpose computers or special-purpose computers, such as any other device capable of executing or responding to an instruction. The processing device may perform an operating system (OS) and one or more software applications executed on the OS. Furthermore, the processing device may access, store, manipulate, process and generate data in response to the execution of software. For convenience of understanding, one processing device has been illustrated as being used, but a person having ordinary skill in the art may understand that the processing device may include a plurality of processing elements and/or a plurality of types of processing elements. For example, the processing device may include a plurality of processors or a single processor and a single controller. Furthermore, a different processing configuration, such as a parallel processor, is also possible.

Software may include a computer program, a code, an instruction or a combination of one or more of them and may configure a processing device so that the processing device operates as desired or may instruct the processing devices independently or collectively. The software and/or the data may be embodied in any type of machine, a component, a physical device, a computer storage medium or a device in order to be interpreted by the processor or to provide an instruction or data to the processing device. The software may be distributed to computer systems connected over a network and may be stored or executed in a distributed manner. The software and the data may be stored in one or more computer-readable recording media.

The method according to various embodiments may be implemented in the form of a program instruction executable by various computer means and stored in a computer-readable medium. In this case, the medium may continue to store a program executable by a computer or may temporarily store the program for execution or download. Furthermore, the medium may be various recording means or storage means having a form in which one or a plurality of pieces of hardware has been combined. The medium is not limited to a medium directly connected to a computer system, but may be one distributed over a network. Examples of the medium may be magnetic media such as a hard disk, a floppy disk and a magnetic tape, optical media such as a CD-ROM and a DVD, magneto-optical media such as a floptical disk, and media configured to store program instructions, including, a ROM, a RAM, and a flash memory. Furthermore, other examples of the medium may include recording media and/or storage media managed in an app store in which apps are distributed, a site in which various other pieces of software are supplied or distributed, a server, etc.

Various embodiments of this document and the terms used in the embodiments are not intended to limit the technology described in this document to a specific embodiment, but should be construed as including various changes, equivalents and/or alternatives of a corresponding embodiment. Regarding the description of the drawings, similar reference numerals may be used in similar elements. An expression of the singular number may include an expression of the plural number unless clearly defined otherwise in the context. In this document, an expression, such as “A or B”, “at least one of A and/or B”, “A, B or C” or “at least one of A, B and/or C”, may include all of possible combinations of listed items together. Expressions, such as “a first,” “a second,” “the first” or “the second”, may modify corresponding elements regardless of its sequence or importance, and are used to only distinguish one element from the other element and do not limit corresponding elements. When it is described that one (e.g., a first) element is “(functionally or communicatively) connected to” or “coupled with” the other (e.g., a second) element, one element may be directly connected to the other element or may be connected to the other element through another element (e.g., a third element).

The term “module” used in this document may include a unit implemented as hardware, software or firmware, and may be interchangeably used with a term, such as logic, a logical block, a part, or a circuit. The module may be an integrated part or a minimum unit in which one or more functions are performed or a part thereof. For example, the module may be implemented as an application-specific integrated circuit (ASIC).

According to various embodiments, each (e.g., a module or a program) of the aforementioned elements may include a single entity or a plurality of entities. According to various embodiments, one or more of the aforementioned components or steps may be omitted or one or more other components or steps may be added. Alternatively or additionally, a plurality of components (e.g., modules or programs) may be integrated into a single component. In such a case, the integrated component may identically or similarly perform a function performed by a corresponding one of the plurality of components before one or more functions of each of the plurality of components. According to various embodiments, steps performed by a module, a program or another component may be executed sequentially, in parallel, iteratively or heuristically, or one or more of the steps may be executed in different order or may be omitted, or one or more other steps may be added.

The embodiments of the disclosure in which an exclusive property or privilege is claimed are defined as follows:

1. A method by a computer system, comprising:
regularizing data sets of a plurality of domains;
extracting information shared between the regularized data sets; and
implementing a training model by performing training based on the extracted shared information.

2. The method of claim 1, further comprising transferring the training model to a target domain.

3. The method of claim 2, wherein the extracting of the shared information extracts the shared information by encoding the regularized data sets over a single neural network.

4. The method of claim 3, wherein the neural network is a convolution neural network (CNN).

5. The method of claim 3, wherein the regularizing of the data sets comprises extracting, from each of the data sets, feature data to be inputted to the neural network, and wherein the extracting of the shared information comprises extracting the shared information based on the feature data.

6. The method of claim 5, wherein the regularizing of the data sets reinforces complexity of the feature data to be extracted from each of the data sets by using a batch spectral penalization (BSP) algorithm.

7. The method of claim 1, wherein the implementing of the training model performs adversarial training through a single discriminator.

8. A computer system comprising:
a memory; and
a processor connected to the memory and configured to execute at least one instruction stored in the memory,
wherein the processor is configured to:
regularize data sets of a plurality of domains,
extract information shared between the regularized data sets, and
implement a training model by performing training based on the extracted information.

9. The computer system of claim 8, wherein the processor is configured to transfer the training model to a target domain.

10. The computer system of claim 9, wherein the processor comprises an encoder configured to extract the shared information by encoding the regularized data sets over a single neural network.

11. The computer system of claim 10, wherein the neural network is a convolution neural network (CNN).

12. The computer system of claim 10, wherein the processor is configured to:
extract, from each of the data sets, feature data to be inputted to the neural network, and
extract the shared information based on the feature data.

13. The computer system of claim 12, wherein the processor is configured to reinforce complexity of the feature data to be extracted from each of the data sets by using a batch spectral penalization (BSP) algorithm.

14. The computer system of claim 8, wherein the processor comprises a single discriminator configured to perform adversarial training.

15. A non-transitory computer-readable storage medium for storing one or more programs to execute a method comprising:
regularizing data sets of a plurality of domains;
extracting information shared between the regularized data sets; and
implementing a training model by performing training based on the extracted shared information.

16. The non-transitory computer-readable storage medium of claim 15, wherein the method further comprises transferring the training model to a target domain.

17. The non-transitory computer-readable storage medium of claim 16, wherein the extracting of the shared information extracts the shared information by encoding the regularized data sets over a single neural network.

18. The non-transitory computer-readable storage medium of claim 17, wherein the neural network is a convolution neural network (CNN).

19. The non-transitory computer-readable storage medium of claim 17, wherein the regularizing of the data sets comprises extracting, from each of the data sets, feature data to be inputted to the neural network, and
the extracting of the shared information comprises extracting the shared information based on the feature data.

20. The non-transitory computer-readable storage medium of claim 19, wherein the regularizing of the data sets reinforces complexity of the feature data to be extracted from each of the data sets by using a batch spectral penalization (BSP) algorithm.
